(19) United States
(12) Patent Application Publication
(10) Pub. No.: US 2001/0046648 A1
(43) Pub. Date: Nov. 29, 2001

(54) Antifoggant concentrate for preparing or replenishing a photographic color developer

(75) Inventor: Francoise M. Thomas, Chalon-Sur-Saone (FR)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 09/802,387

(22) Filed: Mar. 9, 2001

(30) Foreign Application Priority Data
Apr. 7, 2000 (FR) FR 0004445

(51) Int. Cl. G03C 5/305; G03C 5/31

(52) U.S. Cl. 430/399; 430/489; 430/466

(57) ABSTRACT

The invention relates to an aqueous concentrated solution of a photographic antifoggant. This antifoggant is 3-nitrobenzene sulfonate of sodium, and the solution contains between about 50 and 150 g/l of this antifoggant.

The invention also relates to a method of preparing a ready-to-use color developer or a replenishment solution for this color developer, used in the processing of photographic film, comprising the step of mixing this concentrated antifoggant solution with a color developing agent and other additives, in any order.

### FIELD OF THE INVENTION

The present invention relates to an antifoggant concentrate for preparing or replenishing a photographic developer solution for color processing photographic films.

### BACKGROUND OF THE INVENTION

In the scope of processing color photographic films, color developers are used that comprise as main ingredient a color developing agent in an alkaline medium. These color developers further comprise additional ingredients such as antifoggants, preservatives, etc.

The sensitometric characteristics of processed films are dependent on the parameters of the processing: temperature, pH, and concentration of ingredients as well as other factors. These parameters must then be continuously controlled. Further, as the processing itself consumes the reactants introduced at the start in the baths, then these baths have to be maintained or replenished. For this purpose processing manuals propose formulas for replenishment baths, in particular for replenishing developers. These replenishment baths are typically introduced after a certain number of hours of using the developer, or after the processing of a certain amount of film. This replenishment system does not raise too many problems in continuous operation, especially in the case of large installations for processing motion picture films operating continuously, or substantially continuously. However, when such an installation does not operate continuously, but intermittently, for example for less than 8 hours a day, replenishment of the development is then also carried out intermittently, in proportion to the use of the developer. Some ingredients of the developer can then decompose between less frequent replenishments. This means that for intermittent use, replenishment must be provided that is capable of compensating the decomposition losses of some unstable ingredients. This is particularly the case for antifoggants of the dinitrobenzoic acid type. It can be seen that the precaution consisting in providing for specific replenishment in the case of intermittent developer use represents a serious complication of the processing process.

For example, the “Manual for Processing Eastman Motion Picture Films, Module 7, Process ECN-2-specifications”, EKC, 1990, page 21, gives the following information for replenishing a developer with antifoggant #9, according to the use rate:

| Use time hours/day | Antifoggant quantity g/l |
|---|---|
| 2 or less | 0.46 |
| 4 | 0.42 |
| 6 | 0.38 |
| 8 | 0.34 |
| 10 or more | 0.30 |

The normal quantity of antifoggant in the developer replenishment bath is 0.30 g/l. Antifoggant #9 is a dinitrobenzoic acid whose insufficient stability requires providing a specific additional replenishment in case of intermittent developer use. It may be seen that, the more the use of the developer is intermittent, the more the antifoggant concentration in the replenishment bath must be increased. Thus, the standard replenishment can no longer be used for intermittent use, without risking an alteration of the sensitometric characteristics of the processed films.

It is also known to package the various ingredients of a color developer separately. In this way, photographic processing kits are provided that usually comprise several parts, each containing one or more ingredients of the developer. These various parts are mixed and eventually diluted by the end user in order to obtain the ready-to-use color developer. This packaging in several parts is necessary because the various ingredients of the color developer have limited stability in time when they are in the same solution. For example, antifogant #9 is introduced using a powder that is dissolved in the developer. The use of powder is not easy because the powder must be dissolved in water and does not allow a rapid preparation of a ready-to-use developer.

### SUMMARY OF THE INVENTION

The present invention provides a concentrated aqueous solution of a compound having the formula:

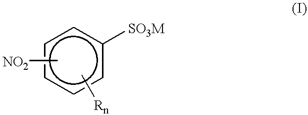

where M represents an alkali metal or ammonium ion;

R represents an alkyl group with 1 to 3 carbon atoms; and

n is the integer 0, 1, 2 or 3,

the compound of formula (I) being present in the solution in a quantity in the range of from about 50 to 150 g/l and, advantageously, from about 60 to 100 g/l. According to an embodiment, compound of formula (I) is an antifoggant. This concentrated aqueous solution of antifoggant allows, by simple dilution, easy preparation of a ready-to-use developer that is as stable as possible while preventing the storage and transport of large volumes of water.

The invention also relates to the use of this concentrate to prepare a ready-to-use color developer that comprises the mixture of this concentrate with a concentrate containing a color developing agent and other additives, in any order.

### DETAILED DESCRIPTION OF THE INVENTION

According to a preferred embodiment, in the compound of the above formula (I), the nitro group is in the meta or para position in relation to SO₃M and n is 0, i.e. the benzene nucleus is unsubstituted. According to another embodiment, the nitro group is in the meta or para position in relation to SO₃M, R represents a methyl group and n is 1, 2 or 3.

In the scope of the invention, the antifoggant of formula (I) can be 3-nitro-benzene sulfonic acid, or 4-nitro-benzene sulfonic acid, in the form of a salt, for example a sodium, potassium, lithium, or ammonium salt.

In all cases, the antifoggant concentrate according to the invention can be diluted to obtain a ready-to-use developer containing between about 2×10 mole/l and 3×10⁻³ mole/l (0.350 g/l) of compound (I).

According to a particular embodiment, the antifoggant concentrate comprises 3-nitrobenzene sulfonic acid in the form of a sodium salt with a concentration in the range of from about 60 g/l to 100 g/l.

The antifoggant concentrate of the present invention represents a particularly simple packaging as it is presented as a very concentrated liquid solution. It enables rapid and easy preparation of the ready-to-use developer by the end user.

Further, the invention provides a concentrate that enables good sensitometric properties to be obtained in the photographic films processed, in particular a low level of fog with reduced speed deterioration.

The antifoggant concentrate of the present invention is a basic (low pH) solution obtained by simply dissolving a sodium salt of nitrobenzene sulfonic acid in water. Preferred solution is made without the need for addition of alkaline compounds such as sodium or potassium carbonate, borax, sodium or potassium hydroxide, sodium metaborate in aqueous solution.

The developing agent can be packaged as a separate concentrate. Usually the developing agent is a p-phenylene diamine, for example 2-amino-5-diethylaminotoluene (known as CD2 sold by Eastman Kodak Company), 4-amino-N-ethyl-N-(β-methanesulfoamidoethyl)-m-toluidine (CD3), 4-amino-3-methyl-N-ethyl-N-(β-hydroxyethyl)-aniline (CD4). CD2 is usually used in color developers for positive cinema films; CD3 is usually used in color developers for motion picture negative and intermediate films. The concentration of the development agent and the volume of concentrated solution to be used will be adapted to obtain a ready-to-use developer having a concentration of development agent of at least about 7×10⁻³ mole/l, preferably in the range of from about 9×10⁻³ to 2×10⁻² mole/l. The concentrate containing the color development agent can contain other compounds such as for example antioxidants or surfactants. Antioxidants that can be used are, for example, sulfites, metabisulfites and bisulfites of alkali metals, or sulfur compounds capable of generating sulfite ions in aqueous solutions, hydroxylamine derivatives, ascorbic acid and its derivatives, etc. For example, the concentrate can comprise CD3 as development agent and sulfite. The pH of this concentrate is maintained acidic, preferably in the range of from 2.5 to 3.5. Useful developer concentrates are described in U.S. Pat. No. 5,843,630 (Masson).

The concentrate containing the developing agent can be mixed with the concentrate of the invention and other ingredients containing the antifoggant just prior to use, either to prepare the developer, or to prepare the replenishment or maintenance solution intended to maintain the efficiency of the developer during use. Thus, in accordance with another aspect of the invention, there is provided a method of preparing a ready-to-use color developer or a replenishment solution for this color developer, used in the processing of photographic film, comprising the step of mixing a concentrated antifoggant solution with a color developing agent and other additives, in any order

wherein the concentrated solution contains from about 50 to 150 g/l of an antifoggant having the formula (I)

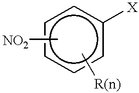

wherein X is —SO₃M with M chosen from among an alkaline or ammonium metal ion, R is an alkyl radical with 1 to 3 carbon atoms, n is the integer 0, 1, 2 or 3.

As noted, other well known ingredients may be included in the mixed developer. These other well-known ingredients are for example alkaline agents such as bicarbonate, sodium hydroxide, potassium hydroxide, ammonia, bromide; water softeners, etc. Usual ingredients are described in Research Disclosure, September 1994, Item 36544, Section XIX. Development. Research Disclosure is a publication of Kenneth Mason Publications, Ltd., Dudley House, 12 North Street, Emsworth, Hampshire P107DQ England.

As said above, the concentrates and other ingredients can be mixed in any order. For instance, the concentrate containing the color developing agent and the usual additives can be added to an appropriate volume of water, and then the antifoggant concentrate according to the invention can be added to the solution obtained. Finally, the volume can be completed by adding water. Alternatively, the volumes and concentrations of the concentrates can be such that their mixture enables a liter of bath to be obtained without the need to dilute the mixture further.

The developer can contain other compounds. For example, antiseptic compounds, heat stabilizers, development activators such as thioether or oxothioether compounds, benzylamine, and sequestering or water softening agents can be added, as described in Research Disclosure, September 1996 Item 38957, Section XIX. Development.

After the concentrates are mixed, the pH may be adjusted to a value between 10 and 12 and advantageously between 10 and 11, possibly with a buffer solution, to obtain a ready-to-use color developer or replenishment solution. Suitable buffer compositions include sodium carbonate and sodium bicarbonate as described in Research Disclosure, September 1996, Item 38957, Section XIX. Development, sub-section E. Other additives.

According to a particular embodiment, the concentrate of the present invention is used to prepare a developer for processing negative motion picture films, such as Eastman Color Negative® film sold by Eastman Kodak Company. Conventionally, this processing comprises a color development step with CD3, a bleaching step, and a fixing step. The bleaching step and the fixing step can be replaced by one single bleaching-fixing step. One or more wash baths can be inserted in between each of these steps. This process is known in the trade as the “ECN-2 Process” and is described, for example, in the “Manual for Processing Eastman Motion Picture Films, Module 7, Process ECN-2-specifications”, EKC, 1990.

The present invention is illustrated by the following examples:

### EXAMPLE 1

### Comparative

A color developer and a replenishment bath for the ECN-2 process were prepared, which had the following composition, in compliance with the “Manual for Processing Eastman Motion Picture Films, Module 7, Process ECN-2-specifications”, EKC, 1990, page 21. Antifoggant No 9 was introduced using a powder that was dissolved in the developer.

| | Developer | Replenishment |
|---|---|---|
| Water at 27° C. | 800 ml | 800 ml |
| Kodak water softener No 4 ⁽¹⁾ | 2.0 ml | 2.7 ml |
| Anhydrous sodium sulfite | 2.0 g | 2.5 g |
| Antifoggant No 9 ⁽²⁾ | 0.22 g | 0.48 g ⁽³⁾ |
| Anhydrous sodium bromide | 1.20 g | 0.93 g |
| Anhydrous sodium carbonate | 26.6 g | 25 g |
| Sodium bicarbonate | 2.7 g | 0.6 g |
| Kodak CD-3 developer ⁽⁴⁾ | 4.0 g | 5.1 g |
| Water to | 1 liter | 1 liter |
| pH at 25° C. | 10.23 | 10.25 |

⁽¹⁾ pentasodium salt of aminotrimethylene-phosphonic acid
⁽²⁾ 3,5-dinitrobenzoic acid;
⁽³⁾ quantity adjusted according to daily use of the developer equal to or less than 2 hours;
⁽⁴⁾ 4-amino-N-ethyl-N-(β-methylsulfonamidoethyl)-m-toluidine

It can be seen that if the standard quantity of antifoggant in the developer is 0.30 g/l, the content of antifoggant in the replenishment bath must be increased to allow for this agent's instability.

An accelerated stability test was carried out: the above developer bath, freshly prepared is kept in a plastic bottle at 50° C. The quantity of antifoggant remaining in the bottle was measured periodically by HPLC up to a maximum duration of 24 days.

The results obtained are given in Table I below.

### EXAMPLE 2

The operating method of Example 1 was repeated, except that antifoggant No 9 was replaced by 0.233 g/l of sodium salt of 3-nitrobenzene sulfonic acid in the developer and in the replenishment bath. The sodium salt of 3-nitrobenzene sulfonic acid was used as an aqueous solution of 70 g/l of 3-nitrobenzene sulfonate of sodium that was introduced directly into the developer. Then, the other bath ingredients were added.

The results of the stability test are given in Table I below.

TABLE I

Quantity of
antifoggant remaining (%)

| Day | Ex 1 Comp. | Ex 2 |
|---|---|---|
| 0 | 100 | 100 |
| 3 | 72 | 100 |
| 9 | 35 | 100 |
| 16 | 9 | 100 |
| 24 | 1 | 98 |

It can be seen from the results that the color developer prepared with the concentrated antifoggant solution of the invention retained substantially all of its antifoggant activity even after 24 days while the comparative developer had little antifoggant remaining after 16 days and substantially no antifoggant after 24 days.

### EXAMPLE 3

A stability test was carried out under the conditions described in Example 1, except that a Kodak ECN-2 color developer prepared as in example 2 was used. A sample of this used developer (seasoning) was taken at the overflow outlet of the developer tank, just before stopping the processing machine. This sample contained 0.360 g/l antifoggant. Another sample of the same developer was taken after 70 hours with the machine stopped, just before restarting it. The antifoggant concentration in this second sample was 0.358 g/l. This test simulated the conditions of intermittent operation of the processing machine and it showed that the concentration of antifoggant had substantially not changed. The developer could thus be replenished with a standard bath.

### EXAMPLE 4

A color negative film, Eastman Color Intermediate 5274® was exposed through a 21 density step wedge, each of these ranges having an 0.15 LogE increment with exposure light having a color temperature of 2850° K and a D1 illuminant and for 1/50 sec. D1 is a tungsten illuminant allowing to increase the color temperature from 2850° K to 3200° K. The sample was developed using Kodak ECN-2 process that included the developer prepared in Example 2, a bleaching bath, a fixing bath, and a final washing bath. The developer was maintained with the replenishment bath specified in Example 1, except that the 3,5-dinitrobenzoic acid was replaced by the sodium salt of 3-nitrobenzene sulfonic acid.

By reading in the three colors blue, green and red on a densitometer, the following sensitometric results were obtained (seasoning bath).

| | Red | Green | Blue |
|---|---|---|---|
| | sensitive layer | sensitive layer | sensitive layer |
| Dmin (+ 0.04) | 0.178 (0.176) | 0.600 (0.594) | 0.958 (0.96) |
| Dmax (+ 10) | 1.40 (1.399) | 2.03 (2.035) | 2.32 (2.33) |
| Contrast (+ 0.04) | 0.530 (0.532) | 0.576 (0.581) | 0.564 (0.572) |
| Speed (+ 4) | 516.5 (516.1) | 527.8 (527.2) | 514.6 (514.) |

( ): value obtained when the developer contained 3,5-dinitrobenzoic acid instead of the sodium salt of 3-nitrobenzene sulfonic acid.

Dmin=minimum density for an unexposed part of the film (medium+fog).

Dmax=maximum density of the film.

Speed=100(3-LogE), E being the quantity of illumination at the Dmin+1 density point.

Contrast=slope of line between the Dmin+0.20 density point and that of the higher quantity illumination of 1.35 LogE.

It showed that the concentrated antifoggant solution introduced in a color developer enables good sensitometric properties to be obtained in the photographic films processed, in particular a low level of fog with reduced speed deterioration.

### EXAMPLE 5

A time stability test was carried out on samples of a solution of 70 g/l of 3-nitrobenzene sulfonate of sodium at various temperatures and at relative humidity %. The concentration in antifoggant was measured periodically by HPLC up to a maximum duration of 130 days. The results obtained are given in the table below.

| | Antifoggant concentration (g/l) | | |
|---|---|---|---|
| Days | 5° C. | 25° C. | 50° C. |
| 0 | 69.66 | 69.66 | 69.66 |
| 10 | 69.66 | 70.09 | 69.93 |
| 24 | 68.9 | 69.8 | 69.3 |
| 38 | 69.8 | 69.34 | 69.84 |
| 52 | 69.38 | 70.18 | 70.79 |
| 57 | 67.27 | 68.29 | 68.82 |
| 73 | 67.79 | 68.06 | 69.12 |
| 87 | 69.43 | 70.01 | 69.35 |
| 102 | 69.43 | 68.93 | 70.4 |
| 116 | 69.01 | 69.76 | 70.56 |
| 130 | 69.87 | 69.64 | 70.38 |

It showed that the concentration of antifoggant had substantially not changed even after 130 days and for all tested temperatures.

The invention has been described in detail with particular reference to certain preferred embodiments thereof, but it will be understood that variations and modifications can be effected within the spirit and scope of the invention.

What we claimed:

1. A concentrated antifoggant solution to be introduced in a color developer or in a replenishment solution for this color developer, wherein the concentrated solution contains from about 50 to 150 g/l of an antifoggant having the formula (I) 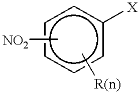
wherein x is —SO₃M with M chosen from among an alkaline or ammonium metal ion, R is an alkyl radical with 1 to 3 carbon atoms, n is the integer 0, 1, 2 or 3.

2. The concentrated solution of claim 1, containing from about 60 to 100 g/l of the antifoggant.

3. The concentrated solution of claim 1, wherein the antifoggant has a nitro group in meta position with respect to X.

4. The concentrated solution of claim 1, wherein the antifoggant has a nitro group in para position with respect to X.

5. The concentrated solution of claim 1, wherein n is 0.

6. A method of preparing a ready-to-use color developer or a replenishment solution for this color developer, used in the processing of photographic film, comprising the step of mixing a concentrated antifoggant solution with a color developing agent and other additives, in any order
wherein the concentrated solution contains from about 50 to 150 g/l of an antifoggant having the formula (I) 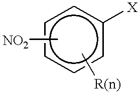
wherein X is —SO₃M with M chosen from among an alkaline or ammonium metal ion, R is an alkyl radical with 1 to 3 carbon atoms, n is the integer 0, 1, 2 or 3.

7. The method of claim 6, wherein the concentrated antifoggant solution contains from about 60 to 100 g/l of the antifoggant.

8. The method of claim 6, wherein the antifoggant has a nitro group in meta position with respect to X.

9. The method of claim 6, wherein the antifoggant has a nitro group in para position with respect to X.

10. The method of claim 6, wherein n is 0.
